(19) United States
(12) Patent Application Publication
(10) Pub. No.: US 2023/0223628 A1
(43) Pub. Date: Jul. 13, 2023

(54) Bipolar Battery

(71) Applicants: Furukawa Electric Co., Ltd., Tokyo (JP); The Furukawa Battery Co., Ltd., Yokohama (JP)

(72) Inventors: Akira Tanaka, Tokyo (JP); Masanobu Aragaki, Tokyo (JP); Kenichi Suyama, Tokyo (JP); Yasuo Nakajima, Tokyo (JP); Hiroki Tanaka, Tokyo (JP); Yoshinobu Taira, Iwaki (JP); Kenji Hirota, Fukushima (JP)

(21) Appl. No.: 18/188,867

(22) Filed: Mar. 23, 2023

Related U.S. Application Data
(63) Continuation of application No. PCT/JP2021/028488, filed on Jul. 30, 2021.

(30) Foreign Application Priority Data
Sep. 30, 2020 (JP) 2020-165687

(51) Int. Cl. H01M 50/198; H01M 10/18; H01M 50/121

(52) U.S. Cl. CPC H01M 50/198; H01M 10/18; H01M 50/121

(57) ABSTRACT

A bipolar battery that can achieve both a hermetic seal and mechanical strength and increases energy density is described. The bipolar lead acid battery includes an outer wall integrally projected along a peripheral edge on a facing surface of one frame-plate out of a pair of the frame-plates facing each other and a joining wall integrally projected on a facing surface of the other frame-plate out of the pair of the frame-plates facing each other. The joining wall is positioned inwardly from the outer wall of the one frame-plate and surrounds a peripheral edge of a cell member. The joining wall is joined to the facing surface of the one frame-plate by a joining material.

### CROSS-REFERENCE TO RELATED APPLICATION

This application is a continuation of PCT/JP2021/028488, filed Jul. 30, 2021, which is incorporated herein in its entirety by reference.

### TECHNICAL FIELD

This disclosure relates to a bipolar battery.

### BACKGROUND

A bipolar battery is configured such that cell members and substrates made of resin are alternately provided in multiple layers. The cell members are each configured such that an electrolyte layer containing electrolyte such as sulfuric acid is provided between a positive electrode and a negative electrode, each having a metal layer made of lead or the like and an active material layer. A frame made of resin and surrounding a cell is disposed between the substrates facing each other so that the cell members are electrically connected in series to each other (see, for example, JP Patent Publication No. JP 2017-508241 A and so on).

### SUMMARY

In the conventional bipolar battery as described above, the substrate is joined to the frame to prevent the electrolyte from leaking outside, and the bipolar battery is stored inside an outer packaging case to prevent a jointed part from stress. Thereby, a hermetic seal and mechanical strength are maintained. Accordingly, the conventional bipolar battery as described above causes an increase in parts and an increase in volume and consequently leads to a decrease in energy density.

In view of this, an object of the present invention is to provide a bipolar battery that can achieve a hermetic seal and mechanical strength and that can also increase energy density.

A bipolar battery according to an embodiment of the present invention to solve the above problem is a bipolar battery in which cell members are connected in series to each other by alternately stacking the cell members and frame-plates in multiple layers. The cell members can each be configured such that an electrolyte layer is provided between a positive electrode and a negative electrode. The frame-plates are made of resin and can be configured such that the cell members are accommodated in the frame-plates. The bipolar battery includes an outer wall integrally projected along a peripheral edge on a facing surface of one frame-plate out of frame-plates facing each other and a joining wall integrally projected on a facing surface of the other frame-plate out of the frame-plates facing each other. The joining wall is positioned inwardly from the outer wall of the one frame-plate and surrounding a peripheral edge of a corresponding one of the cell members. The joining wall of the other frame-plate is joined to the facing surface of the one frame-plate via a joining material.

With a bipolar battery according to the teachings herein, the outer wall is projected along the peripheral edge of the frame-plate, the joining wall is projected inwardly from the outer wall, and the joining wall is joined to the facing surface of the frame-plate via the joining material. Accordingly, it is possible to prevent electrolyte from leaking outside and to prevent a joining-material part from stress, and consequently, it is possible to maintain a hermetic seal and mechanical strength. As a result, it is not necessary to accommodate the bipolar battery inside an outer packaging case or the like, and therefore, it is possible to reduce parts and to achieve compactness of the bipolar battery. Thus, it is possible to achieve both a hermetic seal and mechanical strength and to increase energy density.

### BRIEF DESCRIPTION OF THE DRAWINGS

FIG. 1 is a sectional view illustrating a schematic structure of a first embodiment of a bipolar battery according to the present invention.

FIG. 2 is a sectional view illustrating a schematic structure of a second embodiment of the bipolar battery according to the present invention.

FIG. 3 is a sectional view illustrating a schematic structure of a third embodiment of the bipolar battery according to the present invention.

### DETAILED DESCRIPTION

Embodiments of a bipolar battery according to the present invention will be described with reference to the drawings, but the present invention is not limited only to the embodiments to be described below with reference to the drawings.

### First Embodiment

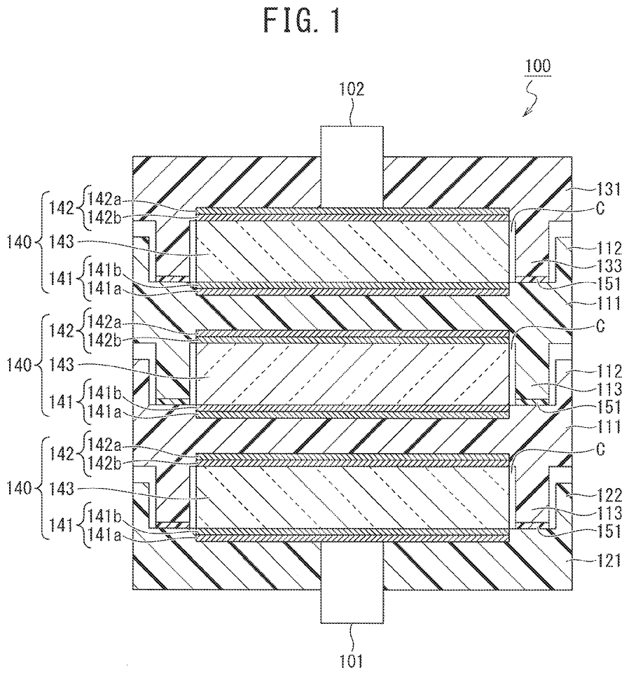

A first embodiment of the bipolar battery according to the present invention will be described with reference to FIG. 1.

As illustrated in FIG. 1, inside a bipolar lead acid battery 100 according to the present embodiment, a plurality of substrates 111, each serving as a frame-plate forming a square flat plate shape and made of thermoplastic resin having sulfuric-acid resistance (e.g., polyethylene, polypropylene, polystyrene, polyvinyl chloride, polymethylmethacrylate (acryl resin), acrylonitrile-butadiene-styrene copolymer (ABS), polyamide (nylon), polycarbonate, and so on) is arranged to face each other at intervals. On one end side (in FIG. 1, a lower end side) in an arrangement direction of the substrates 111 of the bipolar lead acid battery 100, a first end plate 121 serving as a frame-plate forming a square flat plate shape and made of thermoplastic resin having sulfuric-acid resistance is arranged similarly to the substrates 111. On the other end side (in FIG. 1, an upper end side) in the arrangement direction of the substrates 111 of the bipolar lead acid battery 100, a second end plate 131 serving as a frame-plate forming a square flat plate shape and made of thermoplastic resin having sulfuric-acid resistance is arranged similarly to the substrates 111.

On the other surfaces (in FIG. 1, upper surfaces) of the substrates 111 and the first end plate 121, positive-electrode lead layers 141a made of lead or lead alloy, provided as metal layers for positive electrode, are disposed respectively. On the positive-electrode lead layers 141a, positive active material layers 141b containing an active material are disposed respectively. A positive electrode 141 is formed by the positive-electrode lead layer 141a and the positive active material layer 141b.

On one surface (in FIG. 1, lower surfaces) of each of the substrates 111 and the second end plate 131, negative-electrode lead layers 142a made of lead or lead alloy, provided as metal layers for negative electrode, are disposed respectively. On the negative-electrode lead layers 142a, negative active material layers 142b containing an active material are disposed respectively. A negative electrode 142 is formed by the negative-electrode lead layer 142a and the negative active material layer 142b.

An electrolyte layer 143 such as a glass-fiber mat impregnated with electrolyte such as sulfuric acid is disposed between the positive electrode 141 and the negative electrode 142. Cell members 140 are each formed by the positive electrode 141, the negative electrode 142, and the electrolyte layer 143. The cell members 140 are electrically connected in series to each other by well-known means. For example, the substrate 111 includes means by which the positive-electrode lead layer 141a is electrically connected to the negative-electrode lead layer 142a. Note that, in FIG. 1, 101 indicates a positive electrode terminal, and 102 indicates a negative electrode terminal.

That is, the cell members 140 are connected in series to each other such that the cell members 140 and the frame-plates 111, 121, 131 are alternately stacked, the cell members 140 are each configured such that the electrolyte layer 143 is provided between the positive electrode 141 and the negative electrode 142, and the frame-plates 111, 121, 131 are made of resin and configured such that the cell members 140 are accommodated in the frame-plates 111, 121, 131.

On the other surfaces (in FIG. 1, the upper surfaces) of the substrates 111, respective outer walls 112 made of thermoplastic resin having sulfuric-acid resistance and forming a square frame shape along respective peripheral edges are integrally projected. On the one surfaces (in FIG. 1, the lower surfaces) of the substrates 111, respective joining walls 113 made of thermoplastic resin having sulfuric-acid resistance are integrally projected such that the respective joining walls 113 are positioned closer to the inner side of the substrates 111 than the respective outer walls 112 on the other surfaces (in FIG. 1, the upper surfaces) of the substrates 111 to surround respective peripheral edges of the cell members 140.

On the other surface (in FIG. 1, the upper surface) of the first end plate 121, an outer wall 122 made of thermoplastic resin having sulfuric-acid resistance and forming a square frame shape along a peripheral edge of the first end plate 121 is integrally projected. On the one surface (in FIG. 1, the lower surface) of the second end plate 131, a joining wall 133 made of thermoplastic resin having sulfuric-acid resistance is integrally projected such that the joining wall 133 is positioned closer to the inner side of the substrate 111 facing the second end plate 131 than the outer wall 112 on the other surface (in FIG. 1, the upper surface) of the substrate 111 and surrounds the peripheral edge of the cell member 140.

That is, the outer wall 112, 122 is integrally projected along the peripheral edge on a facing surface (in FIG. 1, an upper surface) of one frame-plate 111, 121 (in FIG. 1, on the lower side) out of a pair of the frame-plates facing each other, and the joining wall 113, 133 is integrally projected on a facing surface (in FIG. 1, on a lower surface) of the other frame-plate 111, 131 (in FIG. 1, on the upper side) out of the pair of the frame-plates facing each other. The joining wall 113, 133 is positioned inwardly from the outer wall 112, 122 of the one frame-plate 111, 121 (in FIG. 1, on the lower side) and surrounds the peripheral edge of the cell member 140.

A distal end (in FIG. 1 a bottom end) of the joining wall 133 of the second end plate 131 is joined to the other surface (in FIG. 1, the upper surface) of the substrate 111 facing the second end plate 131, by an adhesive 151 (e.g., an epoxy resin adhesive) with sulfuric-acid resistance and provided as a joining material. A distal end (in FIG. 1, a bottom end) of the joining wall 113 of the substrate 111 facing the first end plate 121 is joined to the other surface (in FIG. 1, the upper surface) of the first end plate 121 by the adhesive 151. A distal end (in FIG. 1, a bottom end) of the joining wall 113 of the other substrate 111 (in FIG. 1, on the upper side) out of the substrates 111 facing each other is joined to the other surface (in FIG. 1, the upper surface) of one substrate 111 (in FIG. 1, on the lower side) by the adhesive 151.

That is, the joining wall 113, 133 of the other frame-plate 111, 131 (in FIG. 1, on the upper side) is joined to the facing surface (in FIG. 1, the upper surface) of the one frame-plate 111, 121 (in FIG. 1, on the lower side) by the adhesive 151 (also called a joining material).

Respective gaps are formed between the outer wall 122 of the first end plate 121 and the one surface (in FIG. 1, the lower surface) of the substrate 111 facing the first end plate 121 and between the outer wall 122 and the joining wall 113. Respective gaps are formed between the one surface (in FIG. 1, the lower surface) of the second end plate 131 and the outer wall 112 of the substrate 111 facing the second end plate 131 and between the outer wall 112 and the joining wall 133 of the second end plate 131. Respective gaps are formed between the outer wall 112 of the one substrate 111 (in FIG. 1, on the lower side) out of the substrates 111 facing each other and the one surface (in FIG. 1, the lower surface) of the other substrate 111 (in FIG. 1, on the upper side) and between the outer wall 112 and the joining wall 113.

That is, a gap is formed between the outer wall 112, 122 of the one frame-plate 111, 121 (in FIG. 1, on the lower side) and the facing surface (in FIG. 1, the lower surface) of the other frame-plate 111, 131 (in FIG. 1, on the upper side). Also, a gap is formed between the outer wall 112, 122 of the one frame-plate 111, 121 (in FIG. 1, on the lower side) and the joining wall 113, 133 of the other frame-plate 111, 131 (in FIG. 1, on the upper side).

Note that, in the present embodiment, each space surrounded and partitioned by the frame-plates 111, 121, 131 facing each other, the joining wall 113, 133, and the adhesive 151 serves as a cell C, and the cell member 140 is accommodated in the cell C.

In the bipolar lead acid battery 100 according to the present embodiment, the joining wall 113, 133 is joined to the facing surface (the other surface) of the substrate 111 or the first end plate 121 facing the joining wall 113, 133 via the adhesive 151. This makes it possible to prevent the electrolyte contained in the electrolyte layer 143 from leaking outside. Further, because the outer wall 112 is provided in a projecting manner along the peripheral edge on the facing surface (the other surface) of the substrate 111 or the first end plate 121, it is possible to prevent the adhesive 151 from stress being applied from outside. Consequently, it is possible to maintain hermetic seal and mechanical strength.

Accordingly, in the bipolar lead acid battery 100 according to the present embodiment, it is not necessary to accommodate the bipolar lead acid battery 100 inside an outer packaging case or the like. Therefore, it is possible to reduce the parts and to achieve compactification of the bipolar lead acid battery 100.

Accordingly, with the bipolar lead acid battery 100 according to the present embodiment, it is possible to achieve both a hermetic seal and mechanical strength and to increase energy density.

That is, in the bipolar lead acid battery 100, the outer wall 112, 122 is projected along the peripheral edge of the frame-plate 111, 121, the joining wall 113, 133 is projected inwardly from the outer wall 112, 122, and the joining wall 113, 133 is joined to the facing surface of the frame-plate 111, 121 by the joining material (e.g., the adhesive 151). Thereby, it is possible to prevent the electrolyte from leaking outside and to prevent the joining material from stress being applied from outside, and consequently, it is possible to maintain a hermetic seal and mechanical strength. As a result, it is not necessary to accommodate the bipolar lead acid battery 100 inside an outer packaging case or the like, and therefore, it is possible to reduce parts and to achieve compactness of the bipolar lead acid battery 100. Consequently, it is possible to achieve a hermetic seal and mechanical strength and to increase energy density.

Further, a gap is formed between the outer wall 112, 122 and the facing surface (the one surface) of the substrate 111 or the second end plate 131 facing the outer wall 112, 122, and a gap is formed between the outer wall 112, 122 and the joining wall 113, 133. Consequently, the outer wall 112, 122 easily bends, and this makes it possible to relieve stress applied from outside and to further reduce external stress to be applied to the adhesive 151.

### Second Embodiment

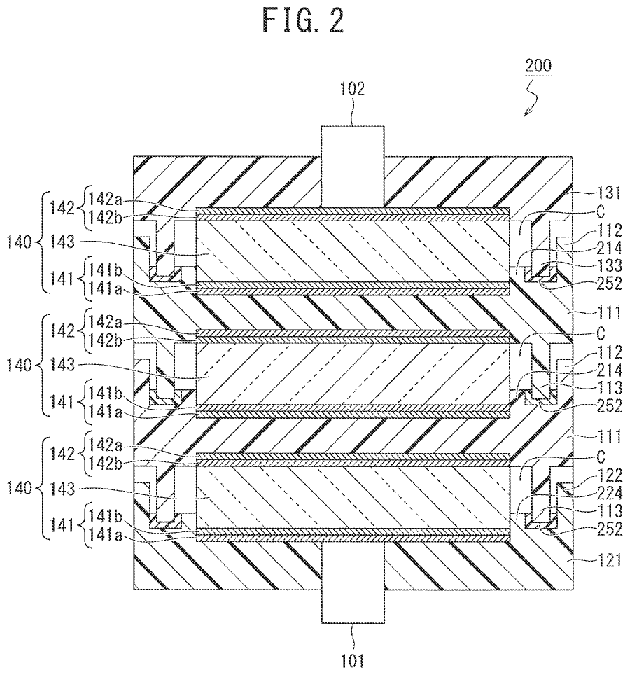

A second embodiment of the bipolar battery according to the present invention will be described with reference to FIG. 2. Note that, for a part similar to a part in the first embodiment, a similar reference sign to a reference sign used in the description of the first embodiment is used, and redundant description is omitted.

As illustrated in FIG. 2, on the other surface (in FIG. 2, the upper surface) of the substrate 111 of a bipolar lead acid battery 200, an inner wall 214 made of thermoplastic resin having sulfuric-acid resistance is integrally projected such that the inner wall 214 is positioned closer to the inner side of the substrate 111 than the joining wall 113 on the one surface (in FIG. 2, the lower surface) of the substrate 111. The inner wall 214 surrounds the peripheral edge of the cell member 140.

On the other surface (in FIG. 2, the upper surface) of the first end plate 121, an inner wall 224 made of thermoplastic resin having sulfuric-acid resistance is integrally projected such that the inner wall 224 is positioned closer to the inner side of the first end plate 121 from the outer wall 112 on the one surface (in FIG. 2, the lower surface) of the substrate 111 facing the first end plate 121. The inner wall 224 surrounds the peripheral edge of the cell member 140.

In summary, the inner wall 214, 224 integrally projected on the facing surface (in FIG. 2, the upper surface) of one frame-plate 111, 121 (in FIG. 2, on the lower side) is provided such that the inner wall 214, 224 is positioned inwardly from the joining wall 113, 133 of the other frame-plate 111, 131 (in FIG. 2, on the upper side) out of the frame-plates and surrounds the peripheral edge of the cell member 140.

A distal end side (in FIG. 2, the lower end side) of the joining wall 113, 133 is joined to the facing surface (the other surface) of the substrate 111 or the first end plate 121 facing the joining wall 113, 133, to the outer wall 112, 122, and to the inner wall 214, 224 via a fusing material 252. The fusing material 252 is a joining material made of thermoplastic resin that is the same material as the substrate 111, the first end plate 121, and the joining walls 113, 133.

That is, the joining wall 113, 133 of the other frame-plate 111, 131 (in FIG. 2, on the upper side) is joined to the facing surface (in FIG. 2, the upper surface) of the one frame-plate 111, 121 (in FIG. 2, on the lower side) by the fusing material (the joining material) 252. Further, the distal end side (in FIG. 2, the lower end side) of the joining wall 113, 133 is joined to the outer wall 112, 122, and the distal end side (in FIG. 2, the lower end side) of the joining wall 113, 133 is joined to the inner wall 214, 224, both by the fusing material (the joining material) 252.

Note that, in the present embodiment, each space partitioned by the frame-plates 111, 121, 131 facing each other, the joining wall 113, 133, the inner wall 214, 224, and the fusing material 252 serves as the cell C and surrounds the cell member 140.

In the bipolar lead acid battery 200 according to the present embodiment, the distal end side (in FIG. 2, the lower end side) of the joining wall 113, 133 is inserted between the outer wall 112, 122 and the inner wall 214, 224 in a pressed manner and is vibrated against the other surface (in FIG. 2, the upper surface) of the substrate 111 or the first end plate 121. As a result, frictional heat is generated (friction of vibration). Thereby, the distal end side of the joining wall 113, 133 and an other-surface part of the substrate 111 or the first end plate 121 that is between the outer wall 112, 122 and the inner wall 214, 224 melt to form a molten material. The molten material then solidifies to become the fusing material 252.

That is, the fusing material 252 is a solidified material generated by melting due to friction of vibration between the joining wall 113, 133 of the other frame-plate 111, 131 (in FIG. 2, on the upper side) and the facing surface (in FIG. 2, the upper surface) of the one frame-plate 111, 121 (in FIG. 2, on the lower side) and then solidifying the molten material. In other words, the fusing material may be a molten material generated by welding processing.

Then, the fusing material 252 fuses the distal end side of the joining wall 113, 133 to the other-surface part of the substrate 111 or the first end plate 121. The fusing material 252 also enters between the distal end side of the joining wall 113, 133 and the outer wall 112, 122 or the inner wall 214, 224 such that the distal end side of the joining wall 113, 133 is joined to the outer wall 112, 122 or the inner wall 214, 224 (vibration welding).

In the bipolar lead acid battery 200 manufactured by vibration welding about the present embodiment, the distal end side of the joining wall 113, 133 is joined to the inner wall 214, 224 and the outer wall 112, 122. As well, the distal end of the joining wall 113, 133 is joined to the facing surface (the other surface) of the substrate 111 or the first end plate 121. Thereby, a joining range of the joining wall 113, 133 can be increased, and the joining strength can be further increased.

Accordingly, with the bipolar lead acid battery 200 according to the present embodiment, it is possible to yield an effect similar to that of the first embodiment. Further, it is possible to more reliably prevent the electrolyte contained in the electrolyte layer 143 from leaking outside while stress from outside is buffered.

### Third Embodiment

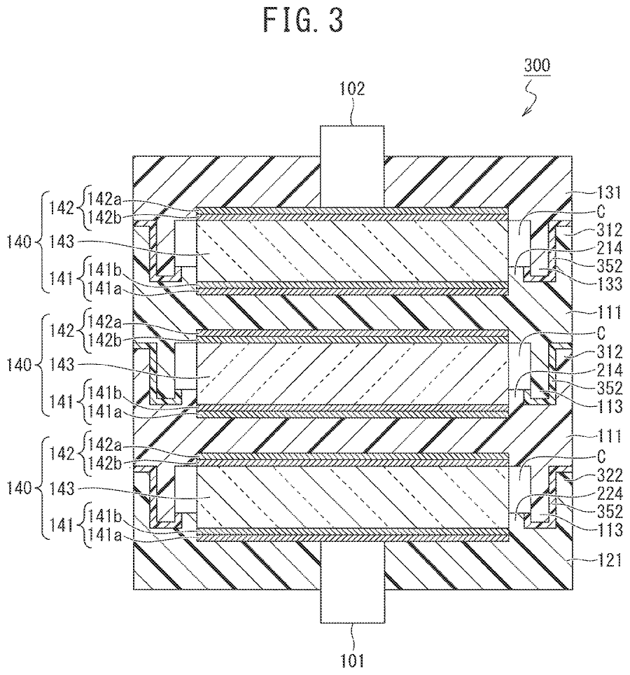

A third embodiment of the bipolar battery according to the present invention will be described with reference to FIG. 3. Note that, for a part similar to a part in the first and/or second embodiment, a similar reference sign to a reference sign used in the description of the first and/or second embodiment is used, and a redundant description is omitted.

As illustrated in FIG. 3, on the other surface (in FIG. 3, the upper surface) of the substrate 111 of a bipolar lead acid battery 300, an outer wall 312 made of thermoplastic resin having sulfuric-acid resistance and forming a square frame shape along the peripheral edge of the substrate 111 is integrally projected. On the other surface (in FIG. 3, the upper surface) of the first end plate 121, an outer wall 322 made of thermoplastic resin having sulfuric-acid resistance and forming a square frame shape along the peripheral edge of the first end plate 121 is integrally projected.

The distal end (in FIG. 3, the lower end) of the joining wall 113, 133 is joined to the other surface (in FIG. 3, the upper surface) of the substrate 111 or the first end plate 121, an inner surface of the outer wall 312, 322 is joined to an outer surface of the joining wall 113, 133, an outer surface of the inner wall 214, 224 is joined to an inner surface of the joining wall 113, 133, and a distal end (in FIG. 3, an upper end) of the outer wall 312, 322 is joined to the one surface (in FIG. 3, the lower surface) of the substrate 111 or the second end plate 131. All are joined by a fusing material 352 that is a joining material made of thermoplastic resin that is the same material as the substrate 111, the first end plate 121, the second end plate 131, the joining wall 113, 133, and the outer wall 312, 322.

That is, the joining wall 113, 133 of the other frame-plate 111, 131 (in FIG. 3, on the upper side) is joined to the facing surface (in FIG. 3, the upper surface) of the one frame-plate 111, 121 (in FIG. 3, on the lower side). The outer wall 312, 322 of the one frame-plate 111, 121 (in FIG. 3, on the lower side) is joined to the joining wall 113, 133 of the other frame-plate 111, 131 (in FIG. 3, on the upper side). The inner wall 214, 224 of the one frame-plate 111, 121 (in FIG. 3, on the lower side) is joined to the joining wall 113, 133 of the other frame-plate 111, 131 (in FIG. 3, on the upper side). The outer wall 312, 322 of the one frame-plate 111, 121 (in FIG. 3, on the lower side) is joined to the facing surface (in FIG. 3, the lower surface) of the other frame-plate 111, 131 (in FIG. 3, on the upper side). All are joined by the fusing material 352.

Note that, in the present embodiment, each space partitioned by the frame-plates 111, 121, 131 facing each other, the joining wall 113, 133, the inner wall 214, 224, and the fusing material 352 serves as the cell C and surrounds the cell member 140.

In the bipolar lead acid battery 300 according to the present embodiment, when the distal end side (in FIG. 3, the lower end side) of the joining wall 113, 133 is inserted between the outer wall 312, 322 and the inner wall 214, 224 in a pressed manner, the distal end (in FIG. 3, the upper end) of the outer wall 312, 322 is pressed against the one surface (in FIG. 3, the lower surface) of the substrate 111 or the second end plate 131.

Then, when the substrate 111 or the second end plate 131 is vibrated against the substrate 111 or the first end plate 121 facing the substrate 111 or the second end plate 131, frictional heat is generated between the distal end of the joining wall 113, 133 and the facing surface (the other surface) of the substrate 111 or the first end plate 121 and between the distal end of the outer wall 312, 322 and the facing surface (the one surface) of the substrate 111 or the second end plate 131 (friction of vibration).

Thereby, the distal end (in FIG. 3, the bottom end) of the joining wall 113, 133 and an other-surface part (in FIG. 3, an upper-surface part) of the substrate 111 or the first end plate 121 that faces the distal end melt and then solidify to become a fusing material 352. Further, the distal end (in FIG. 3, the upper end) of the outer wall 312, 322 and a one-surface part (in FIG. 3, a lower-surface part) of the substrate 111 or the second end plate 131 that faces the distal end melt and then solidify to become a fusing material 352.

That is, the fusing material 352 is a solidified material generated by melting due to friction of vibration between the joining wall 113, 133 of the other frame-plate 111, 131 (in FIG. 3, on the upper side) and the facing surface (in FIG. 3, the upper surface) of the one frame-plate 111, 121 (in FIG. 3, on the lower side) and between the outer wall 312, 322 of the one frame-plate 111, 121 (in FIG. 3, on the lower side) and the facing surface (in FIG. 3, the lower surface) of the other frame-plate 111, 131 (in FIG. 3, on the upper side) and then solidifying.

Then, the fusing material 352 fuses the distal end of the joining wall 113, 133 to a facing-surface part (the other-surface part) of the substrate 111 or the first end plate 121, fuses the distal end of the outer wall 312, 322 to a facing-surface part (the one-surface part) of the substrate 111 or the second end plate 131, and also enters between the joining wall 113, 133 and the outer wall 312, 322 or the inner wall 214, 224 such that the joining wall 113, 133 is joined to the outer wall 312, 322 or the inner wall 214, 224 (vibration welding).

In the bipolar lead acid battery 300 manufactured by vibration welding about the present embodiment, the distal end of the joining wall 113, 133 is joined by vibration welding, Further, the distal end of the outer wall 312, 322 is also welded by vibration. In this way, the outer wall 312, 322 can be joined to the joining wall 113, 133 for overall length as well as the distal end of the outer wall 312, 322.

Accordingly, in the bipolar lead acid battery 300 according to the present embodiment, it is possible to further increase the joining range (area) of the joining wall 113, 133 as compared with the bipolar lead acid battery 200 according to the second embodiment.

Accordingly, in the bipolar lead acid battery 300 according to the present embodiment, although the buffering capacity of the outer wall 112, 122 against stress from outside is decreased, it is possible to further increase the joining strength of the joining wall 113, 133 as compared with the bipolar lead acid battery 200 according to the second embodiment.

### Other Embodiments

Note that the bipolar battery according to the present invention is not limited to the bipolar lead acid batteries 100, 200, 300 according to the first through third embodiments. In other embodiments, for example, for the fusing material 252, 352 of the bipolar lead acid batteries 200, 300 according to the second and third embodiments, welding may be performed by generating a fusing material by other welding processing such as thermal welding by a hot plate or infrared heating, or solvent dissolution, instead of vibration welding.

Further, a bipolar battery may be configured by replacing the adhesive 151 of the bipolar lead acid battery 100 according to the first embodiment with the fusing material 252, 352 of the bipolar lead acid batteries 200, 300 according to the second and third embodiments. Further, a bipolar battery may be configured by replacing the fusing material 252, 352 of the bipolar lead acid batteries 200, 300 according to the second and third embodiments with the adhesive 151 of the bipolar lead acid battery 100 according to the first embodiment.

That is, a bipolar battery can be configured by appropriately changing or replacing various technical matters of the bipolar lead storage batteries 100, 200, 300 according to the first through third embodiments.

Further, the electrical conduction method included in the substrate 111 is not limited to a specific method. For example, when the entire of the substrate contains conductive particles or conductive fiber, both sides of the substrate can be electrically connected. Further, a conductive member enabling electrical conduction can be incorporated into the substrate.

Because the bipolar battery according to the present invention can achieve both a hermetic seal and mechanical strength, and the bipolar battery also increases energy density, the bipolar battery can be used quite effectively for an industrial purpose.

The following is a list of reference numbers used in the drawing figures and in this specification.

100 bipolar lead acid battery
101 positive electrode terminal
102 negative electrode terminal
111 substrate
112 outer wall
113 joining wall
121 first end plate
122 outer wall
131 second end plate
133 joining wall
140 cell member
141 positive electrode
141a positive-electrode lead layer
141b positive active material layer
142 negative electrode
142a negative-electrode lead layer
142b negative active material layer
143 electrolyte layer
151 adhesive
200 bipolar lead acid battery
214 inner wall
224 inner wall
252 fusing material
300 bipolar lead acid battery
312 outer wall
322 outer wall
352 fusing material
C cell

What is claimed is:

1. A bipolar battery, comprising:
cell members connected in series to each other by alternately stacking the cell members and frame-plates in multiple layers, wherein each of the cell members is configured such that an electrolyte layer is provided between a positive electrode and a negative electrode, and the frame-plates are made of resin and configured such that the cell members are accommodated in the frame-plates;
an outer wall integrally projected along a peripheral edge on a facing surface of one frame-plate out of a pair of the frame-plates facing each other; and
a joining wall integrally projected on a facing surface of an other frame-plate out of the pair of the frame-plates facing each other, the joining wall being positioned inwardly from the outer wall of the one frame-plate and surrounding a peripheral edge of a corresponding one of the cell members, wherein the joining wall of the other frame-plate is joined to the facing surface of the one frame-plate via a joining material.

2. The bipolar battery according to claim 1, wherein the joining material is provided between the outer wall of the one frame-plate and the joining wall of the other frame-plate.

3. The bipolar battery according to claim 2, comprising:
an inner wall integrally projected on the facing surface of the one frame-plate, the inner wall being positioned inwardly from the joining wall of the other frame-plate and surrounding the peripheral edge of the corresponding one of the cell members, wherein the inner wall of the one frame-plate is joined to the joining wall of the other frame-plate via the joining material.

4. The bipolar battery according to claim 2, wherein a gap is formed between the outer wall of the one frame-plate and the facing surface of the other frame-plate.

5. The bipolar battery according to claim 2, wherein the joining material is an adhesive or a fusing material.

6. The bipolar battery according to claim 2, wherein the outer wall of the one frame-plate is joined to the facing surface of the other frame-plate by the joining material.

7. The bipolar battery according to claim 2, wherein the resin is thermoplastic resin.

8. The bipolar battery according to claim 1, comprising:
an inner wall integrally projected on the facing surface of the one frame-plate, the inner wall being positioned inwardly from the joining wall of the other frame-plate and surrounding the peripheral edge of the corresponding one of the cell members, wherein the inner wall of the one frame-plate is joined to the joining wall of the other frame-plate by the joining material.

9. The bipolar battery according to claim 8, wherein a gap is formed between the outer wall of the one frame-plate and the facing surface of the other frame-plate.

10. The bipolar battery according to claim 8, wherein the joining material is an adhesive or a fusing material.

11. The bipolar battery according to claim 8, wherein the outer wall of the one frame-plate is joined to the facing surface of the other frame-plate by the joining material.

12. The bipolar battery according to claim 8, wherein the resin is thermoplastic resin.

13. The bipolar battery according to claim 1, wherein a gap is formed between the outer wall of the one frame-plate and the facing surface of the other frame-plate.

14. The bipolar battery according to claim 13, wherein the joining material is an adhesive or a fusing material.

15. The bipolar battery according to claim 1, wherein the joining material is an adhesive or a fusing material.

16. The bipolar battery according to claim 15, wherein the fusing material is a solidified material generated by welding processing between the joining wall of the other frame-plate and the facing surface of the one frame-plate.

17. The bipolar battery according to claim 1, wherein the outer wall of the one frame-plate is joined to the facing surface of the other frame-plate by the joining material.

18. The bipolar battery according to claim 17, wherein the joining material is an adhesive or a fusing material.

19. The bipolar battery according to claim 18, wherein the fusing material is a molten material generated by welding processing between the joining wall of the other frame-plate and the facing surface of the one frame-plate and between the outer wall of the one frame-plate and the facing surface of the other frame-plate.

20. The bipolar battery according to claim 1, wherein the resin is thermoplastic resin.
